(19) United States
(12) Patent Application Publication
(10) Pub. No.: US 2019/0142554 A1
(43) Pub. Date: May 16, 2019

(54) DISPOSITION INTRODUCED IN DENTAL IMPLANT PIN

(71) Applicant: THUM INSTITUTO DE PÓS-GRADUAÇÃO E BIOPESQUISAS LTDA ME, JOINVILLE (BR)

(72) Inventor: LOTARIO THUM, JOINVILLE-SC (BR)

(73) Assignee: THUM INSTITUTO DE PÓS-GRADUAÇÃO E BIOPESQUISAS LTDA ME, JOINVILLE-SC (BR)

(21) Appl. No.: 15/811,955

(22) Filed: Nov. 14, 2017

(51) Int. Cl. A61C 8/00

(52) U.S. Cl. CPC A61C 8/0028; A61C 8/0037

(57) ABSTRACT

A disposition introduced in dental implant pin to improve and speed healing of the area after insertion of the implant pin. To this end, a pin (P) containing improvements has a central diametral reduction section (6) of diametrical reduction provided with thread fillets (7), forming a space between the bone mass (M) which will allow blood clot accumulation and natural secretions of the patient's body responsible for the prompt restoration and healing of the injured region in a considerably reduced time, besides the creation of intra-implant bone rings, offering greater support to the pin body (P), providing better dissipation of the pressure exerted during mastication .

This descriptive report refers to the utility model patent application for an improvement introduced into a dental implant pin, which receives new external configurations that guarantee ease of introduction into the bone mass of the patient and better anchoring of the implant.

The new arrangement applied to this biocompatible titanium alloy implant pin forms a central region of smaller diameter (recessed) in its body, provided with left-handed threaded threads forming recessed rings, as well as thread in superior conicity and also a lower bulging thread that, working together, besides providing more comfort to the patient in the recovery, guarantees better adhesion, rapidity in the natural process of osseointegration and reduction of the inflammatory process.

### COMMENTS REGARDING THE STATE OF THE ART

Nowadays with the evolution of dental implants and their techniques of accomplishment, this form of treatment is being increasingly sought and becoming more accessible to the population. An implant pin is basically a part that resembles a screw, with its outer surface that varies between the cylindrical shape with parallel threads and taper shape with conical rocks.

We can see that implant pins are basically on the market in two formats, as said, with parallel threads and conical threads, restricting the changes that differentiate them in the question of the type of threads like hybrid threads, scaled threads, differentiating only in the treatment of surfaces that can be by thermal spraying, spray plasma application, anodic oxidation (anodizing), bioceramic layer surface, surface treatment by hydrochloric, sulfuric and other acids, but always maintaining the same external characteristics.

What has been observed in this more specific area, that is, implantology is that with the use of these configurations of implant pins, the compression of the bone on the surface of these pins has taken place, which ended up causing a healing problem with respect to the implant. free exchange and formation of new immediate vascularization. The compacting and maceration of the bone on the surface of the implants inhibits and compresses all the liquids and blood accumulated in the bone tissue, the sealing of the sectioned vessels occurring in the opening of the implant receiving bed, which becomes a big problem because in the first stage the blood, responsible for the transport of oxygen, and the liquids that carry all the nutrients to the tissues and main responsible for the regeneration of the tissues, are blocked.

Thus, since free exchange and formation of new vascularization do not occur, the organism itself needs to work harder to install a mechanism to remove compressed and necrotic bone caused by compaction and absence of oxygen, so that reconstitution elements can be allowed to access to the surface of the implant pin to form new nutrient vessels, and only then properly initiate the process of bone formation on the pin, with osseointegration between implant/bone occurring.

Due to the occurrence of this compaction the recovery and, consequently, the treatment end up being prolonged, causing the patient to have higher costs, thus preventing the access of a large part of the population to this treatment.

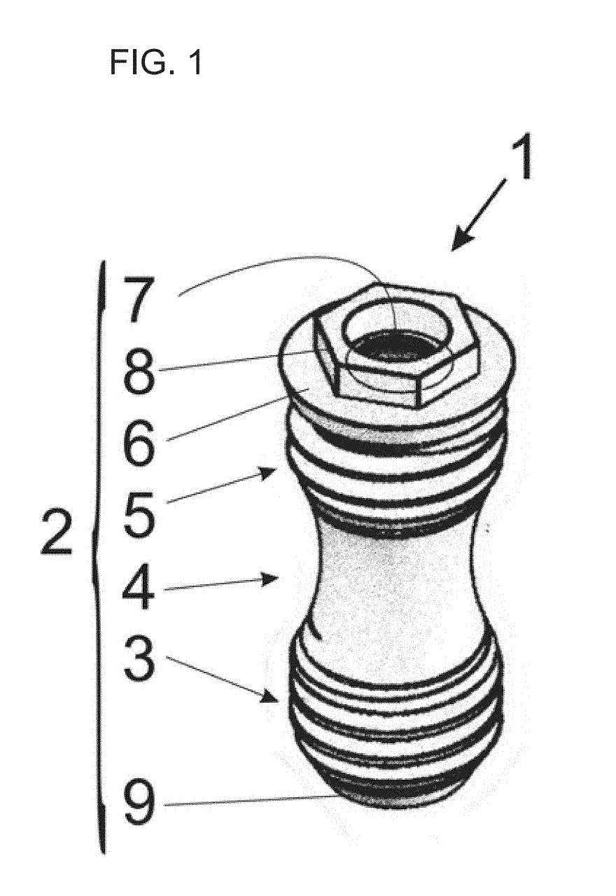

A pin of current configurations comprising some solutions to the above described problems can be appreciated through the patent document BR 102014021198-5, filed by the applicant himself with the utility model patent application to be described hereinafter. In this application BR 10 2014 021198-5 quoted, exemplified as FIG. 1, an implant pin is proposed that includes concave-shaped threads at its ends and a gradual reduction of diameter in the central part of its body, which promotes a space between the pin and the bone mass of the patient, in order to allow the clot to accumulate blood and protein secretions responsible for the prompt restoration and healing of the injured region. The above-mentioned pin, in spite of its high functionality, having a smooth central part, does not yet provide total dissipation of force pressure at the moment of mastication throughout the bone area around the implant.

### PURPOSE OF THE INVENTION

This is precisely one of the objectives of the pin, the reason for this patent application, proposing the creation of an implant with a configuration that offers less aggressiveness when it is introduced, allowing regeneration to be done quickly and avoiding the stress state of the implant patient's body by compacting the bone to the implant.

Thus, the implant pin has a cylindrical body with different diameters in its parts, the upper and lower concave ends having self-tapping active threads with spaced and high thread threads called “superb thread”. The central region of the pin presents a decrease in diameter, with variable left-handed thread fillets in order to create a space between the pin and the bone mass so that blood clot accumulation and protein secretions are possible responsible for the prompt restoration and healing of the injured region, receiving nutrients from the bone wall through micro-vascularizations and trabecular bone tissue, storing blood and tissue fluids due to the lack of compression of the implant thread, besides allowing the formation of bone rings during healing, expressively improving the surface and providing better dissipation of force pressure at the moment of mastication throughout the bone area around the implant. At the upper end, the pin has a flange in the form of a cap or tuft that closes by pressure of the bone bed.

As a result of this new arrangement, it is easy to install, significantly reducing osseointegration time for only three weeks and the possibility of prosthetic solutions known as immediate loading, in addition to the reduction of cost of production compared to conventional ones due to simplification in machining and material reduction used, thus allowing a fairer and more real social integration, reaching the less favored population.

In addition to the advantages already mentioned, this innovative arrangement in implant pin extends to people with risk factors, as is the case of people with lack of bone area at the implant site, that is, with a more compact, nutrient-deficient bone area and with reduced irrigation. With the formation of the space between the implant and the bone mass, even these patients can present the nourished and alive blood clot, occurring the bone regeneration. The same occurs with patients with diabetes, for example, or smokers, who also have great difficulty in regeneration. When the implant is installed in its place, with a blood clot and free access of the tissue fluids, the process of osseointegration begins immediately, significantly reducing patient recovery, resulting in quality bone formation on the surface of the implant.

Described briefly, it passes the implant pin to be better understood through the drawings.

FIG. 1, as stated above, refers to the state of the art, showing the implant pin created by the author of this patent application.

The following figures, from 2 to 6, refer to the pin in question, the subject of this patent application:

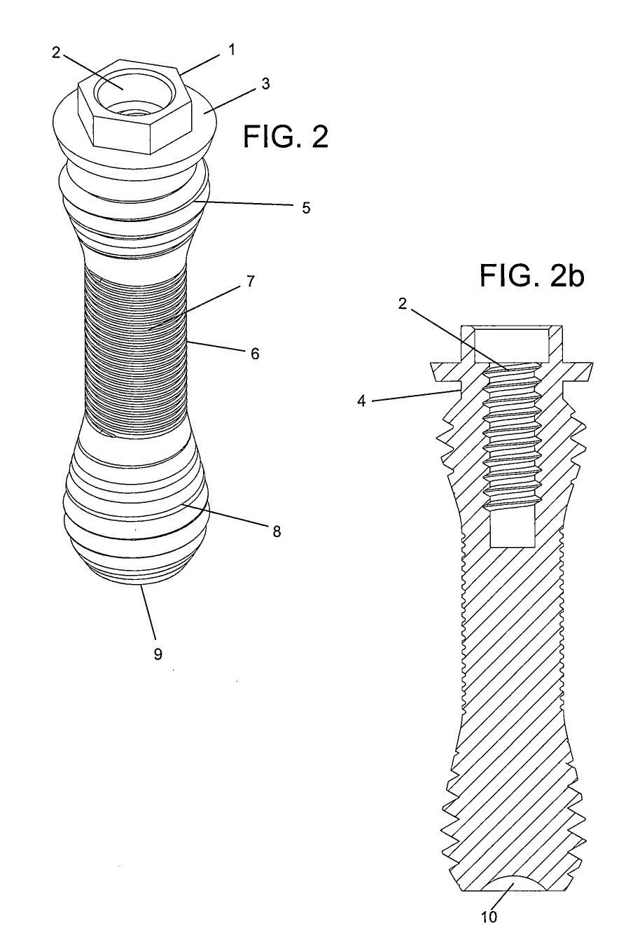

FIG. 2—perspective view of the implant pin from its top in hexagonal shape, also showing its conical contour flange and two superb type stretches delimiting a rectilinear section of smaller diameter with thin threads.

FIG. 2b—the internal threaded bore of the pin;

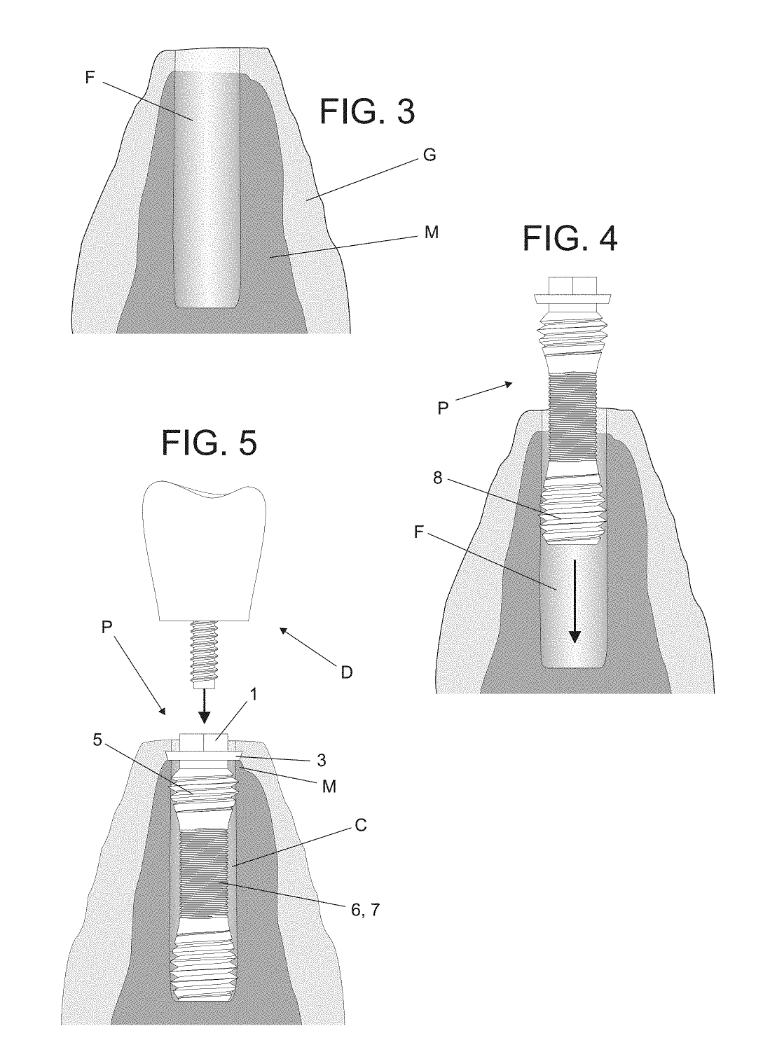

FIG. 3—Schematic view of the bone mass of the patient surrounded by the gingiva, in which a bore-hole was made for the insertion of the pin;

FIG. 4—view according to the previous figure, with the pin being inserted into the borehole from its lower superb type thread;

FIG. 5—view according to the previous figure showing that, after inserted in the borehole, the rectilinear segment of smaller diameter of the pin forms a space between this and the bone mass of the patient and the pin receives, from its hexagonal shoulder, the tooth of implant;

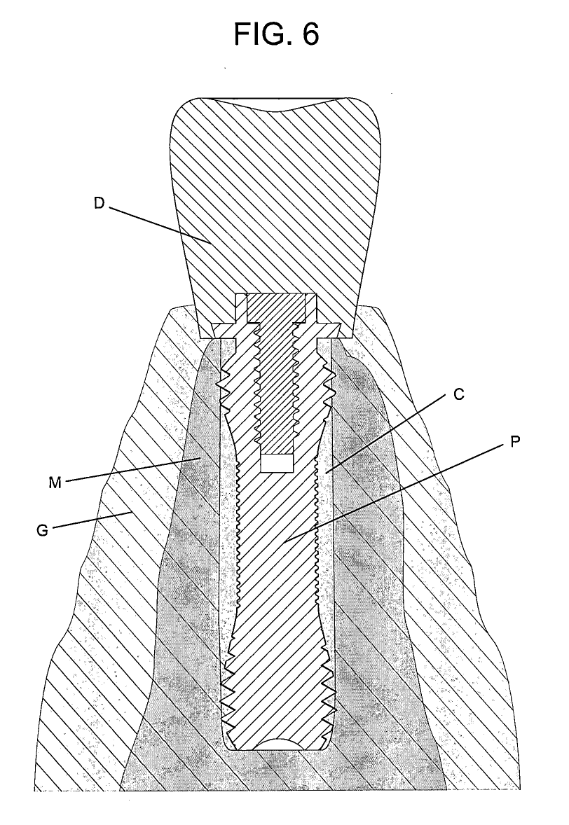

FIG. 6 shows the cut of bone mass already calcified around the pin, which has already received the implant tooth.

According to the attached figures, the subject of this utility model patent application is supported by a cylindrical body pin (P) formed by a top hexagonal shoulder (1), with (2), followed by a conical contour flange (3) terminating in a short neck (4), from which a superb thread (5) extends, projecting in a concave shape. Below this is a smaller vertical central rectilinear section (6) which receives left-handed thin thread (7), at the end of which a. second concave contour lower thread (8) terminates at a linear end (9) having a central rounded recess (10).

Thus, by default, after removal of the tooth to be replaced by the implant (I), the dental surgeon performs a borehole (F) per drill in the patient's bone mass (M) from the upper layer of the gingiva (G) in which the pin (P) in question is then introduced by threading from its lower superb thread (8), less aggressively than the traditional pins due to the shape of its body in a diametrical con figuration, with which the bone mass (M) receives pressure by threading only in its two short stretches of superb (8), lower, and (5) upper thread. At the end of the introduction of said pin (P), its conical contour flange (3) rests on the edge of the bed bore (F) of the bone mass (M), serving as a kind of cap which will thus seal the borehole (F), avoiding contamination of the external means.

Thus housed in the bed, the pin (P) in question, because of its differentiated diametrical configuration, creates a space between the bone mass (M) and its vertical central rectilinear section (6) of smaller diameter, such as a chamber (C), which will allow the accumulation of blood clot and natural secretions of the patient's body, which are responsible for the prompt restoration and healing of the injured region in a considerably reduced time.

When the healing and osseointegration around the pin (P) is complete thanks to the thin threaded threads (7) of its rectilinear segment (6) of smaller diameter, intraosseous bone rings are created, giving greater support to the pin body (P), thereby providing better dissipation of the pressure exerted during chewing, thus the pin (P) being ready to receive the implant tooth (D) by threading through the threaded bore hole (2) from its hexagonal shoulder (I).

1. (canceled)

2. A dental implant for replacement of teeth comprising:
a cylindrical body, the cylindrical body further comprising:
a central region with:
a decreased diameter relative to the diameter of the cylindrical body upper and lower ends and
left handed threading;
an internal bore-hole at the cylindrical body upper end, the bore hole being threaded; and
the upper and lower ends further comprise self-tapping threads for introduction of the dental implant into a bone mass bore-hole drilled into a patient;
wherein the replacement tooth is implanted by screwing a threaded pin attached to a replacement tooth into the dental implant bore-hole.

3. The dental implant of claim 2 further comprising a hexagonal shoulder at the cylindrical body upper end for screwing the dental implant into the patient's bone mass.

4. A method of replacement of teeth comprising the dental implant of claim 2, comprising the steps:
a dental surgeon drills a bore-hole into a patient's bone mass;
the dental implant is screwed into the bone mass bore-hole using the self-tapping threads; and,
the replacement tooth is screwed into the dental implant internal bore-hole using the threaded pin attached to the replacement tooth.
